(19) United States
(12) Patent Application Publication
(10) Pub. No.: US 2022/0075577 A1
(43) Pub. Date: Mar. 10, 2022

(54) IMAGE FORMING APPARATUS, USER AUTHENTICATION METHOD, AND USER AUTHENTICATION PROGRAM

(71) Applicant: KONICA MINOLTA, INC., Tokyo (JP)

(72) Inventor: Satoshi UCHINO, Toyokawa-shi (JP)

(73) Assignee: KONICA MINOLTA, INC., Tokyo (JP)

(21) Appl. No.: 17/391,149

(22) Filed: Aug. 2, 2021

(30) Foreign Application Priority Data
Sep. 4, 2020 (JP) 2020-148711

(51) Int. Cl. G06F 3/12; G06F 21/32; G06F 21/60; G06K 9/00; H04N 1/00

(52) U.S. Cl. CPC G06F 3/1238; G06F 3/1222; H04N 1/00381; G06F 21/608; G06K 9/00268; G06F 21/32

(57) ABSTRACT

An image forming apparatus includes: a first authenticator that extracts first feature information representing a feature of a face of a user from a face image of the user, and performs face authentication by comparing the first feature information extracted with second feature information representing a feature of the face of the user registered in advance; and a second authenticator that performs authentication of the user by comparing first motion information representing a predetermined motion performed by the user with second motion information representing the predetermined motion of the user registered in advance when at least a part of the information does not match between the first feature information and the second feature information in the face authentication by the first authenticator.

The entire disclosure of Japanese patent Application No. 2020-148711, filed on Sep. 4, 2020, is incorporated herein by reference in its entirety.

### BACKGROUND

### Technological Field

The present invention relates to an image forming apparatus, a user authentication method, and a user authentication program.

### Description of the Related Art

Face authentication has conventionally been widely used in user authentication systems. In face authentication, failure of authentication often occurs due to a change in a user's motion, facial expression, or the like. Thus, a technology has conventionally been devised for improving accuracy of face authentication by causing a direction of the face of the user to be directed in a predetermined direction when the face authentication fails (see, for example, JP 2010-218039 A). A face authentication system described in JP 2010-218039 A includes: a detection means that detects an authentication target person; an imaging means that images the authentication target person detected by the detection means and generates moving image data; a feature extraction means that extracts a feature of a face of the authentication target person on the basis of the moving image data and generates feature information; an authentication means that performs authentication on the basis of the feature information; and a guidance means that guides the authentication target person to cause a direction of the face of the target person to be directed toward the imaging means for greater than or equal to a predetermined time when the feature extraction means fails to extract the feature of the face.

By the way, mask wearing has become widespread all over the world due to influence of recent coronaviruses and the like, and in the face authentication, when a part of the face of the user is covered with the mask or the like, the user cannot be authenticated. In this case, it is necessary to perform face authentication again with the mask removed, or perform contact type passcode authentication or vein authentication. However, in this case, a risk of virus infection occurs, and convenience of face authentication is also reduced. Thus, there is a demand for a technology that enables face authentication in a non-contact manner and without causing the user to put off the mask or the like even when a part of the face of the user is covered with the mask or the like. Note that, the technology disclosed in JP 2010-218039 A is a technology for improving accuracy of face authentication by causing the direction of the face of the user to be directed in a registered face direction when registered information on the direction of the face of the user and an actual direction of the face of the user are different from each other, but is not a technology for authenticating a partially covered face.

### SUMMARY

The present invention has been made to meet the above demand, and an object of the present invention is to provide an image forming apparatus and a user authentication method that enable non-contact and highly convenient user authentication even when a part of the face of the user is covered with a mask or the like at the time of face authentication.

To achieve the abovementioned object, according to an aspect of the present invention, an image forming apparatus reflecting one aspect of the present invention comprises: a first authenticator that extracts first feature information representing a feature of a face of a user from a face image of the user, and performs face authentication by comparing the first feature information extracted with second feature information representing a feature of the face of the user registered in advance; and a second authenticator that performs authentication of the user by comparing first motion information representing a predetermined motion performed by the user with second motion information representing the predetermined motion of the user registered in advance when at least a part of the information does not match between the first feature information and the second feature information in the face authentication by the first authenticator.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIGS. 1A and 1B are diagrams for explaining a face authentication problem that occurs when the face of the user is partially covered;

FIG. 2 is a diagram illustrating an appearance of an image forming apparatus according to an embodiment of the present invention;

FIG. 3 is a block diagram illustrating an internal configuration of the image forming apparatus according to the embodiment of the present invention;

FIG. 4 is a diagram illustrating an example of predetermined motion of a user that can be used in a second authentication process of the image forming apparatus according to the embodiment of the present invention; and

FIG. 5 is a flowchart illustrating a procedure of a user authentication process performed by the image forming apparatus according to the embodiment of the present invention.

### DETAILED DESCRIPTION OF EMBODIMENTS

Hereinafter, an embodiment of the present invention will be specifically described with reference to the drawings. However, the scope of the invention is not limited to the disclosed embodiment.

Before describing the image forming apparatus according to the embodiment of the present invention, a problem that occurs when a face of a user to be authenticated is partially covered will be described more specifically.

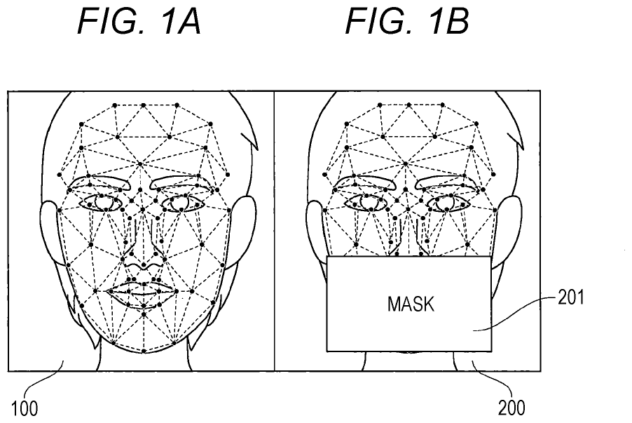

FIGS. 1A and 1B are diagrams for explaining a face authentication problem that occurs when the face of the user is partially covered. An image 100 illustrated in FIG. 1A is an authentication image when the face of the user to be authenticated is not partially covered at the time of face authentication. An image 200 illustrated in FIG. 1B is an authentication image when a part of the face of the user to be authenticated is covered with a mask 201 (mask image) at the time of face authentication.

Note that, when the face authentication is performed using a camera device arranged in the image forming apparatus, the face authentication is performed on the basis of skeleton information for each part in addition to information (hereinafter, referred to as “feature information”.) representing features of the face of the user extracted from a face image imaged, specifically, position information of a part such as an eye, nose, jaw, or the like of the face of the user. Thus, for convenience of description, in FIGS. 1A and 1B, an image of skeleton information (information indicated by broken lines in the figures) for each part of the face is displayed to be superimposed on the face image. Furthermore, the face of the user in the image 200 of FIG. 1B is the same as the face of the user in the image 100 of FIG. 1A.

As illustrated in FIG. 1A, when a part of the face of the user is not covered with the mask 201, the face authentication can be performed as usual. However, as illustrated in FIG. 1B, when the user's mouth and its peripheral portion (part of nose, part of jaw) are covered with the mask 201, the position information and the skeleton information of the covered part cannot be extracted, and the face authentication cannot be performed. In this case, it is necessary to perform face authentication again with the mask removed, or perform contact type passcode authentication or vein authentication. However, in this case, a risk of virus infection occurs, and convenience of face authentication is also reduced.

Note that, here, the face authentication when the user wears the mask has been described as an example; however, for example, when key information at the time of the face authentication such as the outer corners of the eyes, the inner corners of the eyes, the corners of the mouth, or the like of the face is covered with some object or the like other than the mask, a similar problem occurs. The present invention has been made to solve the problems as described above.

[Schematic Configuration of Image Forming Apparatus]

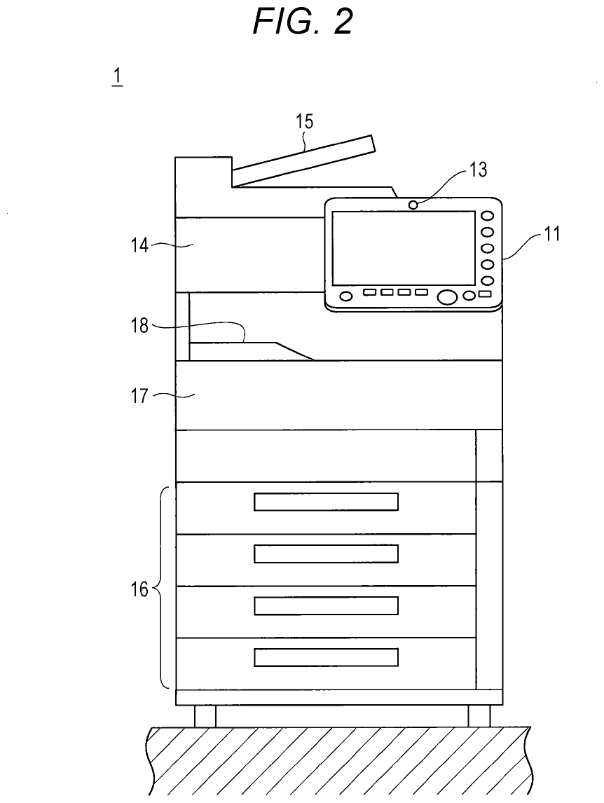

FIG. 2 is a diagram illustrating an appearance of an image forming apparatus according to the embodiment of the present invention. An image forming apparatus 1 according to the present embodiment is a multi-function peripheral (MFP) equipped with a plurality of functions such as a scanner function, a copy function, a facsimile function, a network function, and a BOX function.

As illustrated in FIG. 2, the image forming apparatus 1 includes an operation display unit 11, an imager 13, a scanner 14, an automatic document feeder 15, a recording medium supply unit 16, an image forming unit 17, and a recording medium discharge unit 18.

In the present embodiment, the recording medium supply unit 16, the image forming unit 17, the recording medium discharge unit 18, the scanner 14, and the automatic document feeder 15 are arranged in this order from the lower part of the image forming apparatus 1, and the operation display unit 11 is arranged on the front surface (a surface facing the user) of the scanner 14. Furthermore, the imager 13 is provided at the upper part of a display screen in the operation display unit 11.

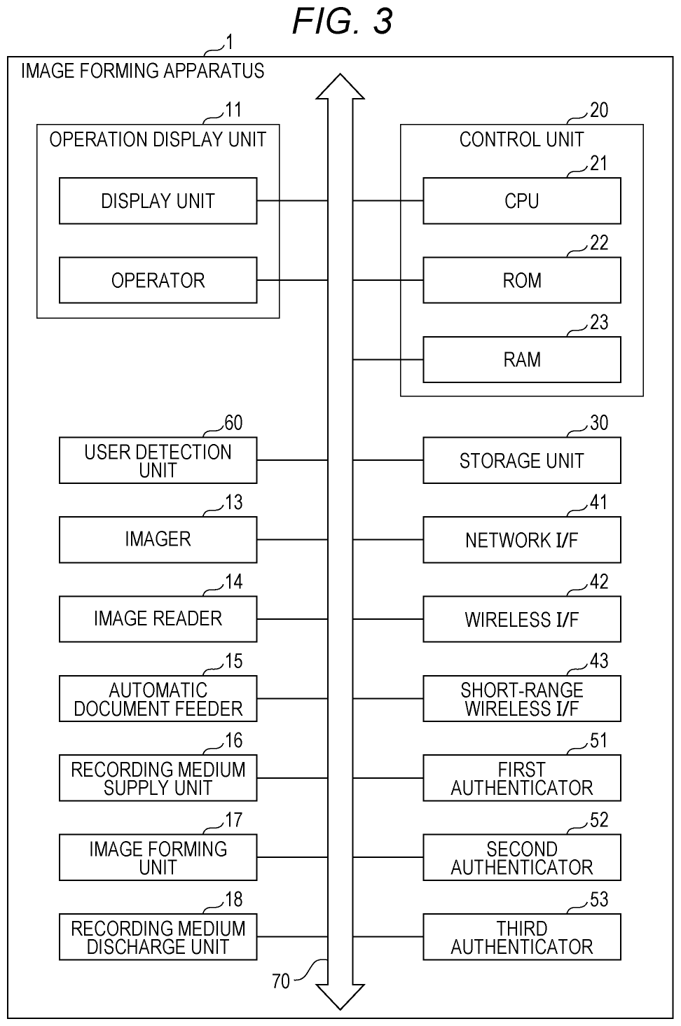

The operation display unit 11 includes a display unit including a display device such as a liquid crystal display (LCD) or an organic electro-luminescence (EL) display, and an operator including various operation keys capable of receiving instructions, characters, numbers, symbols, and the like from the user, a touch sensor, and the like. The display unit and a part (touch sensor) of the operator are integrally formed as, for example, a touch panel. The operation display unit 11 generates an operation signal representing operation content from the user input to the operator, and supplies the operation signal to a control unit 20 described later (see FIG. 3 described later). Furthermore, the operation display unit 11 displays operation content, setting information, and the like by the user on the display unit on the basis of a display signal supplied from the control unit 20 described later. Note that, the operator may include a mouse, a tablet, or the like, and may be configured separately from the display unit.

The imager 13 includes, for example, a camera, and images an image of a subject in accordance with a user's operation, and generates image data. Furthermore, in the present embodiment, when performing the face authentication of the user, the imager 13 images the face, motion, and the like of the user to be authenticated in front of the operation display unit 11, and generates image data. Note that, the imager 13 outputs the image data generated at the time of the face authentication of the user to a first authenticator 51 described later (see FIG. 3 described later). Note that, in the present embodiment, a configuration has been described in which the image forming apparatus 1 includes the imager 13 (imaging function unit); however, the present invention is not limited thereto. A configuration may be adopted in which the image forming apparatus 1 does not include the imaging function unit, and the imaging function unit is connected from the outside. In this case, as a form of connecting the imaging function unit to the image forming apparatus 1, the imaging function unit may be connected in a wired manner or in a form of wireless communication or the like. Furthermore, in this case, the imaging function unit is preferably arranged near the operation display unit 11 in consideration of convenience of acquisition of motion information in a second authentication process described later.

The scanner 14 is an example of an image reading device including an image sensor and the like, and reads a document image. The scanner 14 optically scans a recording medium on which the document image is formed, and causes reflected light from the recording medium to form an image on a light receiving surface of a charge coupled device (CCD) sensor, and reads the image.

The automatic document feeder 15 includes a placing tray on which a recording medium is placed, a mechanism, a conveying roller, and the like that convey the recording medium, and conveys the recording medium to a predetermined conveying path.

The recording medium supply unit 16 includes a supply tray that stores a recording medium and a conveying unit that conveys the recording medium. The recording medium supply unit 16 conveys the recording medium in the supply tray to the image forming unit 17.

The image forming unit 17 includes components necessary for image formation, and prints a predetermined image on a recording medium on the basis of print job designation information. Specifically, for the recording medium supplied to the recording medium supply unit 16, a process is performed of: forming an electrostatic latent image by irradiating a photoreceptor drum charged by a charging device with light depending on an image from an exposure device; attaching charged toner by a developing device to perform development; performing primary transfer of a developed toner image to a transfer belt; performing secondary transfer of the toner image from the transfer belt to the recording medium; and further fixing the toner image on the recording medium by a fixing device. The recording medium subjected to image formation is discharged to the recording medium discharge unit 18.

The recording medium discharge unit 18 includes a discharge tray. The recording medium discharge unit 18 discharges the recording medium subjected to image formation by the image forming unit 17 to the discharge tray.

[Internal Configuration of Image Forming Apparatus]

FIG. 3 is a block diagram illustrating an internal configuration of the image forming apparatus 1 according to the present embodiment. As illustrated in FIG. 3, the image forming apparatus 1 includes not only the various constituent units described in FIG. 2 but also a control unit 20, a storage unit 30, a network I/F 41, a wireless I/F 42, a short-range wireless I/F 43, the first authenticator 51, a second authenticator 52, a third authenticator 53, and a user detection unit 60. Furthermore, these constituent units are electrically connected to each other by a bus 70, and the bus 70 is a signal path through which signals are input and output between the constituent units. Note that, although not illustrated here, the image forming apparatus 1 includes a microphone and the like, and is provided with a voice recognition unit capable of recognizing user's utterance sound and the like.

The control unit 20 includes a central processing unit (CPU) 21, read only memory (ROM) 22, and random access memory (RAM) 23. The control unit 20 includes, for example, a microprocessor or the like, and performs overall control of the image forming apparatus 1.

The CPU 21 controls operation of each unit in the image forming apparatus 1. For example, the CPU 21 performs control of image forming processing of the image forming unit 17 based on a user's print instruction performed via the operation display unit 11, control of recording medium supply processing by the recording medium supply unit 16, control of image data objectification processing, and the like. Furthermore, in the present embodiment, the CPU 21 also performs control of a first authentication process executed by the first authenticator 51 described later, the second authentication process executed by the second authenticator 52 described later, and a third authentication process executed by the third authenticator 53 described later, at the time of authentication of the face of the user described later.

The ROM 22 includes, for example, a storage medium such as a nonvolatile memory, and stores a program, data, and the like executed and referred to by the CPU 21. Furthermore, in the present embodiment, the ROM 22 stores various types of authentication information for each user used in a user authentication process described later. Specifically, non-contact type authentication information such as feature information of the face of each user or motion information described later, and contact type authentication information such as a passcode, a fingerprint, or a vein are stored. Note that, these various types of authentication information are registered in advance by, for example, operation of the operation display unit 11 by the user.

The RAM 23 includes, for example, a storage medium such as a volatile memory, and temporarily stores information (data) necessary for each process performed by the CPU 21.

The storage unit 30 includes a non-transitory computer-readable recording medium storing a program to be executed by the CPU 21, and includes, for example, a storage device such as a hard disk drive (HDD). The storage unit 30 stores programs and data such as a program for the CPU 21 to control each unit, an operating system (OS), and a controller. Note that, some of the programs and data stored in the storage unit 30 may be stored in the ROM 22. Furthermore, the non-transitory computer-readable recording medium storing the program executed by the CPU 21 is not limited to the HDD, and may be, for example, a recording medium such as a solid state drive (SSD), a compact disc (CD)-ROM, or a digital versatile disc (DVD)-ROM.

The network I/F 41 is a communication interface including a communication integrated circuit (IC), a communication connector, and the like, and transmits and receives various types of information to and from an external device connected via a network using a predetermined communication protocol under the control of the control unit 20.

The wireless I/F 42 includes an antenna, a demodulation circuit, a signal processing circuit, and the like, and performs wireless communication with an external device connected via a network by a wireless communication method such as Wi-Fi (registered trademark).

The short-range wireless I/F 43 includes an antenna, a demodulation circuit, a signal processing circuit, and the like, and performs wireless communication with a mobile terminal or the like possessed by a user who operates the image forming apparatus 1 by a wireless communication method such as Bluetooth (registered trademark) or IrDA (registered trademark).

In accordance with an instruction from the control unit 20, the first authenticator 51 extracts feature information (first feature information) from image data of the face of the user imaged by the imager 13, performs a face authentication process (first authentication process described later) on the basis of the extracted feature information and feature information (second feature information) for authentication of the user registered in advance, and outputs a result of the face authentication process to the control unit 20. Note that, specific content of the face authentication process performed by the first authenticator 51 will be described later in detail.

In accordance with an instruction from the control unit 20, the second authenticator 52 performs an authentication process (second authentication process described later) on the basis of information (hereinafter, referred to as “motion information”: second motion information) representing a predetermined motion executed by the user registered in advance and motion information (first motion information) representing the predetermined motion of the user imaged by the imager 13, or recognized by a voice recognition unit (not illustrated), and outputs a result of the authentication process to the control unit 20. Note that, specific content of the authentication process performed by the second authenticator 52 and the motion information of the user used in the authentication process will be described later in detail.

In accordance with an instruction from the control unit 20, the third authenticator 53 performs an authentication process (third authentication process described later) on the basis of information such as the passcode, fingerprint, or vein for authentication input by the user using the operation display unit 11 and the authentication information (such as the passcode, fingerprint, or vein) of the user registered in advance, and outputs a result of the authentication process to the control unit 20. Note that, specific content of the authentication process performed by the third authenticator 53 will be described later in detail.

The user detection unit 60 includes, for example, a human sensor, and detects a user approaching the operation display unit 11 of the image forming apparatus 1. Upon detecting the user, the user detection unit 60 notifies the control unit 20. Note that, in the present embodiment, upon receiving a notification that the user has been detected from the user detection unit 60, the control unit 20 may control the imager 13 to image the face of the user to be authenticated and start the user authentication process. In this case, the risk of virus infection can be further reduced, and the convenience of user authentication can also be improved.

[User Authentication Method]

Next, an outline will be described of a user authentication method performed by the image forming apparatus 1 according to the present embodiment. The user authentication process of the present embodiment includes the first authentication process, the second authentication process, and the third authentication process, and when the authentication fails in the first authentication process, the second authentication process is performed, and when the authentication also fails in the second authentication process, the third authentication process is performed. Furthermore, in the present embodiment, when the authentication is successful in the first authentication process, the second and third authentication processes are not performed, and when the authentication is successful in the second authentication process, the third authentication process is not performed. That is, the second and third authentication processes are complementary authentication processes of the first authentication process. Note that, the function of the user authentication process of the present embodiment described below may be implemented by software, or may be implemented by hardware.

(1) First Authentication Process

In the first authentication process, the face authentication process is performed, and first, the first authenticator 51 extracts feature information from data of a face image of a user to be authenticated input from the imager 13. Next, the first authenticator 51 performs face authentication by comparing the extracted feature information with feature information for authentication of the user registered in advance. Note that, the feature information for authentication of the user registered in advance is feature information extracted from a face image (FIG. 1A) in which the face of the user is not partially covered with a mask or the like. Then, the first authenticator 51 outputs a result of the face authentication to the control unit 20.

In a comparison process between the feature information of the face image of the user to be authenticated imaged by the imager 13 and the feature information for authentication of the user registered in advance, which is performed in the first authentication process, the first authenticator 51 calculates a matching rate (% expression) of both pieces of feature information. Note that, the matching rate of the feature information here is a ratio of feature information matching between the feature information of the face image of the user to be authenticated imaged by the imager 13 and the feature information for authentication of the user registered in advance, to the feature information for authentication of the user registered in advance.

Note that, as a matching degree between the feature information of the face image of the user to be authenticated imaged by the imager 13 and the feature information for authentication of the user registered in advance, in addition to the matching rate expressed in %, for example, a value not to be expressed in % (0 to 1), a value expressing the matching rate by a qualitative level (for example, levels A, B . . . , or the like), or the like may be adopted. Furthermore, in the present embodiment, in the comparison process between the feature information of the face image of the user to be authenticated imaged by the imager 13 and the feature information for authentication of the user registered in advance, the first authenticator 51 may detect only information of a qualitative comparison result of whether or not the face of the user is partially covered with a mask or the like without calculating the matching rate of the feature information.

(2) Second Authentication Process

The second authentication process is performed when a non-contact type authentication process is performed and the matching rate of the feature information calculated in the first authentication process is greater than 0% and less than 100% (a case other than when the pieces of feature information are completely different from each other and when the pieces of feature information completely match). In the second authentication process, first, the second authenticator 52 informs the user to be authenticated of information instructing the user to perform a predetermined motion (type information of the predetermined motion to be authenticated in the current second authentication process) via the operation display unit 11. Next, when the instructed user to be authenticated performs the predetermined motion, the second authenticator 52 compares motion information (acquired by the imager 13 or the voice recognition unit) of the predetermined motion performed by the user to be authenticated with motion information of the predetermined motion of the user registered in advance, and determines whether or not both match each other to perform authentication.

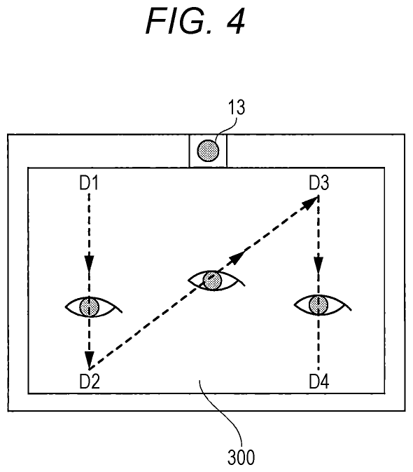

Examples of the predetermined motion for authentication of the user used in the second authentication process include motions such as “gesture”, “utterance (motion of generating predetermined words)”, “change of a direction of the face”, “movement of a line of sight”, and “blinking” Note that, when the predetermined motion is “utterance”, the motion is recognized by the voice recognition unit (not illustrated), and other predetermined motions are imaged (recognized) by the imager 13. Furthermore, as the motion for authentication of the user used in the second authentication process, any operation can be adopted as long as the motion can be authenticated without contacting the image forming apparatus 1 (operation display unit 11). Here, in FIG. 4, an example is illustrated of the “movement of the line of sight” used as the predetermined motion of the user in the second authentication process. The example of an image 300 of “movement of the line of sight” illustrated in FIG. 4 illustrates an example in which the user faces the imager 13 and moves the line of sight to positions D1, D2, D3, and D4 in this order (inverted N-shape) along arrows in the figure. In the present embodiment, motion information of “movement of the line of sight” as illustrated in FIG. 4 is registered in advance in the image forming apparatus 1.

Note that, the motion information registered in advance in the image forming apparatus 1 is registered for each user, and a plurality of types of motion information can be registered. Then, when the plurality of types of motion information is registered, a type of motion information used in the second authentication process is changed for each execution of the second authentication process to improve security. At this time, the type of the motion information may be changed for each execution of the second authentication process depending on the priority order set in advance by the user or the like, or the type of the motion information may be changed randomly for each execution of the second authentication process.

As described above, examples of the motion for authentication of the user used in the second authentication process include motions such as “gesture”, “utterance”, “change of the direction of the face”, “movement of the line of sight”, and “blinking”; however, for example, the motions such as “movement of the line of sight” and “blinking” are finer motions and movement with higher complexity than the motions such as “gesture”, “utterance”, and “change of the direction of the face”. That is, the motion information such as the “movement of the line of sight” and the “blinking” is motion information with higher reliability in the authentication process than the motion information such as “gesture”, “utterance”, and “change of the direction of the face”. Furthermore, for example, in an authentication method by a motion such as “gesture”, “utterance”, and “change of the direction of the face”, there is a high possibility that the authentication information (motion information) is seen (stolen) by another user existing around, but in an authentication method by a motion such as “movement of the line of sight” or “blinking”, there is a low possibility that the authentication information is stolen even if there is another user existing around. Thus, the latter motion can be said to be a motion with higher security than the former motion.

Thus, in the second authentication process of the present embodiment, in consideration of the reliability (security) of each motion described above, when the matching rate of the feature information calculated in the first authentication process is relatively low, the second authentication process using high reliability motion information (for example, motion information such as “movement of the line of sight” and “blinking”) (hereinafter, referred to as “high reliability second authentication process”) is performed. On the other hand, when the matching rate of the feature information calculated in the first authentication process is relatively high, the second authentication process using low reliability motion information (for example, motion information such as “gesture”, “utterance”, and “change of the direction of the face”) (hereinafter, referred to as “low reliability second authentication process”) is performed.

That is, in the second authentication process of the present embodiment, any one of the high reliability second authentication process or the low reliability second authentication process (simple authentication process) is performed depending on the matching rate of the feature information calculated in the first authentication process. Note that, a threshold (any value within a range of greater than 0% and less than 100%) of the matching rate of the feature information used in determination of whether to execute the high reliability second authentication process or the low reliability second authentication process is set by, for example, an administrator or a user of the image forming apparatus 1 performing a predetermined operation on the operation display unit 11 or an external device.

(3) Third Authentication Process

In the third authentication process, a contact type authentication process is performed, and the third authentication process is performed when authentication fails in both the first authentication process and the second authentication process. In the third authentication process, the third authenticator 53 performs authentication by comparing information such as the passcode, fingerprint, or vein input by a touch operation or a pressing operation on a key button of the user to be authenticated on the operation display unit 11 with information such as the passcode, fingerprint, or vein registered in advance by the user. At this time, the authentication may be performed using one type of the authentication information, or the authentication may be performed by combining a plurality of types of the authentication information.

(4) Procedure of User Authentication Process

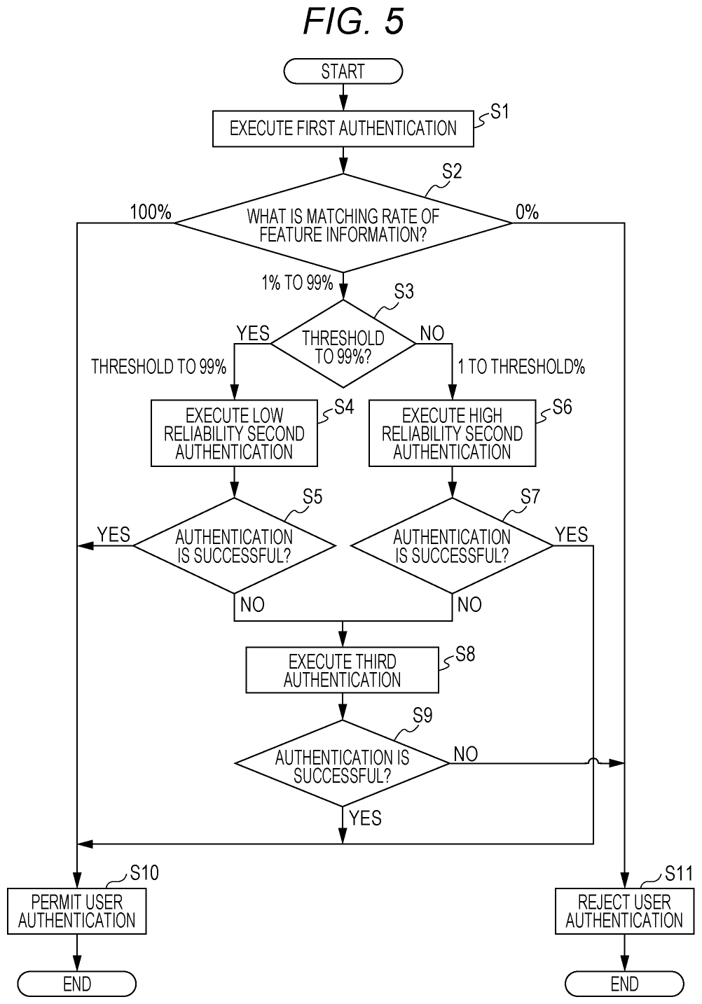

Next, a procedure of the user authentication process performed in the image forming apparatus 1 of the present embodiment will be described with reference to FIG. 5. Note that, FIG. 5 is a flowchart illustrating a procedure of the user authentication process performed by the image forming apparatus 1 of the present embodiment.

When the user performs any operation that triggers execution of a job on the image forming apparatus 1, the control unit 20 controls the imager 13 to image the face of the user to be authenticated, and starts the user authentication process. Note that, in the present embodiment, since the user detection unit 60 that detects the user approaching the operation display unit 11 of the image forming apparatus 1 is included, when the user approaching the user detection unit 60 is detected, the control unit 20 may control the imager 13 to image the face of the user to be authenticated, and start the user authentication process.

First, as illustrated in FIG. 5, the control unit 20 (CPU 21) controls the first authenticator 51 to execute the first authentication process (step S1). In this process, the control unit 20 issues an execution instruction of the first authentication process to the first authenticator 51. Next, upon receiving the execution instruction of the first authentication process from the control unit 20, the first authenticator 51 extracts feature information from the data of the face image of the user to be authenticated input from the imager 13, and compares the extracted feature information with feature information for authentication of the user registered in advance to calculate a matching rate of the feature information. Then, the first authenticator 51 outputs the calculated matching rate of the feature information to the control unit 20.

Next, the control unit 20 determines whether the matching rate of the feature information input from the first authenticator 51 is 100%, 0%, or 1% to 99% (greater than or equal to 1% and less than or equal to 99%) (step S2).

In the process of step S2, when the control unit 20 (CPU 21) determines that the matching rate of the feature information is 100%, that is, when the feature information of the face image of the user imaged by the imager 13 completely matches the feature information for authentication of the user registered in advance, the control unit 20 performs the process of step S10 described later.

In the process of step S2, when the control unit 20 (CPU 21) determines that the matching rate of the feature information is 0%, that is, when the feature information of the face image of the user imaged by the imager 13 is completely different from the feature information for authentication of the user registered in advance, the control unit 20 performs the process of step S11 described later.

Furthermore, in the process of step S2, when the control unit 20 (CPU 21) determines that the matching rate of the feature information is a value within the range of 1% to 99%, that is, when the feature information of the face image of the user imaged by the imager 13 is only partially different from the feature information for authentication of the user registered in advance, the control unit 20 determines whether or not the matching rate of the feature information is a value within the range of the threshold to 99% (greater than or equal to the threshold value and less than or equal to 99%) (step S3).

In the process of step S3, when the control unit 20 (CPU 21) determines that the matching rate of the feature information is a value within the range of the threshold value to 99% (YES in step S3), the control unit 20 controls the second authenticator 52 to execute the low reliability second authentication process (step S4). In this process, the control unit 20 issues an execution instruction of the low reliability second authentication process to the second authenticator 52. Next, upon receiving the instruction to execute the low reliability second authentication process from the control unit 20, the second authenticator 52 performs the low reliability second authentication process. At this time, the second authenticator 52 compares the motion information of the predetermined motion performed by the user to be authenticated at the time of step S4 with the motion information of the predetermined motion of the user registered in advance, and determines whether or not both match each other. Then, the second authenticator 52 outputs a result of the second authentication process to the control unit 20.

After the process of step S4, the control unit 20 (CPU 21) determines whether the authentication is successful in the low reliability second authentication process on the basis of the result of the second authentication process input from the second authenticator 52 (step S5). In this determination process, when the motion information of the predetermined motion performed by the user to be authenticated at the time of step S4 matches the motion information of the predetermined motion of the user registered in advance, it is determined that the authentication is successful (YES), and otherwise, it is determined that the authentication is not successful (NO).

In the process of step S5, when the control unit 20 (CPU 21) determines that the authentication is successful (YES in step S5), the control unit 20 performs the process of step S10 described later. On the other hand, in the process of step S5, when the control unit 20 determines that the authentication is not successful (NO in step S5), the control unit 20 performs the process of step S8 described later.

Here, the description returns to the process of step S3 again. In the process of step S3, when the control unit 20 (CPU 21) determines that the matching rate of the feature information is not a value within the range of the threshold to 99% (NO in step S3), the control unit 20 controls the second authenticator 52 to execute the high reliability second authentication process (step S6). In this process, the control unit 20 issues an execution instruction of the high reliability second authentication process to the second authenticator 52. Upon receiving the instruction to execute the high reliability second authentication process from the control unit 20, the second authenticator 52 performs the high reliability second authentication process. At this time, the second authenticator 52 compares the motion information of the predetermined motion performed by the user to be authenticated at the time of step S6 with the motion information of the predetermined motion of the user registered in advance, and determines whether or not both match each other. Then, the second authenticator 52 outputs a result of the second authentication process to the control unit 20.

After the process of step S6, the control unit 20 (CPU 21) determines whether the authentication is successful in the high reliability second authentication process on the basis of the result of the second authentication process input from the second authenticator 52 (step S7). In this determination process, when the motion information of the predetermined motion performed by the user to be authenticated at the time of step S6 matches the motion information of the predetermined motion of the user registered in advance, it is determined that the authentication is successful (YES), and otherwise, it is determined that the authentication is not successful (NO).

In the process of step S7, when the control unit 20 (CPU 21) determines that the authentication is successful (YES in step S7), the control unit 20 performs the process of step S10 described later. On the other hand, in the process of step S7, when the control unit 20 determines that the authentication is not successful (NO in step S7), the control unit 20 performs the process of step S8 described later.

When the determination in step S5 or S7 is NO, the control unit 20 (CPU 21) controls the third authenticator 53 to execute the third authentication process (step S8). In this process, the control unit 20 issues an execution instruction of the third authentication process to the third authenticator 53. Next, upon receiving the instruction to execute the third authentication process from the control unit 20, the third authenticator 53 performs the third authentication process (contact type authentication). At this time, the third authenticator 53 compares information such as the passcode, fingerprint, or vein input by the user to be authenticated with information such as the passcode, fingerprint, or vein registered in advance by the user, and determines whether or not both match each other. Then, the third authenticator 53 outputs a result of the third authentication process to the control unit 20.

After the process of step S8, the control unit 20 (CPU 21) determines whether the authentication is successful in the third authentication on the basis of the result of the third authentication process input from the third authenticator 53 (step S9). In this determination process, when the information such as the passcode, fingerprint, or vein input by the user to be authenticated matches the information such as the passcode, fingerprint, or vein registered in advance by the user, it is determined that the authentication is successful (YES), and otherwise, it is determined that the authentication is not successful (NO).

In the process of step S9, when the control unit 20 (CPU 21) determines that the authentication is successful (YES in step S9), the control unit 20 performs the process of step S10 described later. On the other hand, in the process of step S9, when the control unit 20 (CPU 21) determines that the authentication is not successful (NO in step S9), the control unit 20 performs the process of step S11 described later.

When it is determined in step S2 that the matching rate of the feature information is 100%, the case of YES in step S5, YES in step S7, or YES in step S9, that is, when the authentication of the user is successful, the control unit 20 (CPU 21) permits the user authentication (step S10). With this process, the user to be authenticated can use the image forming apparatus 1. Then, after the process of step S10, the control unit 20 (CPU 21) ends the user authentication process.

When it is determined in step S2 that the matching rate of the feature information is 0%, or the case of NO in step S9, that is, when the authentication of the user has failed, the control unit 20 (CPU 21) rejects the user authentication (step S11). With this process, the user to be authenticated cannot use the image forming apparatus 1. Then, after the process of step S11, the control unit 20 (CPU 21) ends the user authentication process.

[Effects]

As described above, in a user authentication technology of the present embodiment, in the non-contact type first authentication process (face authentication), when the feature information of the face image of the user to be authenticated imaged by the imager 13 is partially different from the feature information for authentication of the user registered in advance (when a part of the face of the user is covered with a mask or the like), the second authentication process that is the non-contact type authentication process other than the face authentication is executed as complementary authentication of the first authentication process. Thus, in the user authentication technology of the present embodiment, even when the face of the user is partially covered with a mask or the like at the time of face authentication, the user can be authenticated without performing face authentication again with the mask or the like removed, or performing contact type passcode authentication, vein authentication, or the like. In this case, the risk of virus infection can be reduced, and the convenience of user authentication can also be improved. That is, in the image forming apparatus 1 and the user authentication method of the present embodiment, it is possible to provide a technology that enables non-contact and highly convenient user authentication even when a part of the face of the user is covered with a mask or the like at the time of face authentication.

[Various Modifications]

In the above, descriptions have been given of the configuration of the image forming apparatus 1 according to the embodiment of the present invention and the user authentication method in the image forming apparatus 1; however, the present invention is not limited thereto, and various other modifications can be made without departing from the gist of the present invention described in the claims.

In the above embodiment, a configuration example has been described in which in the face authentication of the first authentication process, the user authentication is rejected when the feature information of the face image of the user imaged by the imager 13 is completely different from the feature information for authentication of the user registered in advance (when the matching rate of the feature information is 0%); however, the present invention is not limited thereto. For example, a configuration may be adopted in which in the face authentication of the first authentication process, the second authentication process is executed even when the feature information of the face image of the user imaged by the imager 13 is completely different from the feature information for authentication of the user registered in advance.

In the embodiment and the modification described above, an example has been described in which authentication is performed using a single piece of the motion information in the low reliability second authentication process; however, the present invention is not limited thereto. As described above, motions, for example, “gesture”, “utterance”, “change of the direction of the face” and the like are low security motions, so when these pieces of the motion information are used in the low reliability second authentication process, a configuration may be adopted in which authentication is performed by combining a plurality of types of the motion information to improve security. Furthermore, a configuration may be adopted in which authentication is performed by combining a plurality of types of the motion information also in the high reliability second authentication process.

In the embodiment and the various modifications described above, an example has been described in which two types of the second authentication processes having different degrees of reliability are provided depending on the matching rate of the feature information calculated in the first authentication process, as the second authentication process; however, the present invention is not limited thereto.

For example, the second authentication process may include one type of the second authentication process regardless of the matching rate (excluding 0% and 100%) of the feature information calculated in the first authentication process. In this case, a configuration may be adopted in which regardless of the reliability of the motion information used for authentication, an authentication process similar to the second authentication process described above is performed on each piece of the motion information. Furthermore, in this case, a configuration may be adopted in which the second authentication process is executed only when the matching rate of the feature information calculated in the first authentication process is greater than or equal to a predetermined value and less than 100%, and the second authentication process is not executed when the matching rate of the feature information is less than the predetermined value. That is, for example, the second authentication process may include only the low reliability second authentication process described above. Note that, in this configuration, the predetermined value of the matching rate of the feature information used in the determination of whether the second authentication process is executed is set by the administrator, the user, or the like of the image forming apparatus 1 performing a predetermined operation on the operation display unit 11 or an external device.

Furthermore, for example, the second authentication process may include three or more types of the second authentication processes depending on the matching rate (excluding 0% and 100%) of the feature information calculated in the first authentication process. In this case, classification based on the reliability of the motion information used for authentication is further subdivided (for example, the reliability is classified into high, medium, low, and the like), and the second authentication processes are provided corresponding to degrees of reliability of three or more types of the motion information.

In the embodiment and the various modifications described above, an example has been described in which a plurality of types of the second authentication processes having different degrees of reliability is provided depending on the matching rate of the feature information calculated in the first authentication process; however, the present invention is not limited thereto. For example, a plurality of types of the second authentication process may be provided depending on other information such as a degree of importance of the user (VIP user or the like). In this case, a configuration may be adopted in which, for example, when the degree of importance of the user is high (when the user is a VIP user), the low reliability second authentication process is performed, and when the degree of importance of the user is low, the high reliability second authentication process is performed.

In the embodiment and the various modifications described above, an example has been described in which a plurality of types of motion information for authentication of the user is provided in the second authentication process; however, the present invention is not limited thereto, and a configuration may be adopted in which only one type of motion information for authentication of the user is provided in the second authentication process.

In the embodiment and the various modifications described above, an example has been described in which the motion information is used as the authentication information in the second authentication process; however, the present invention is not limited thereto. For example, usable non-contact type information other than the motion information may be used as the authentication information of the second authentication process.

In the embodiment and the various modifications described above, a configuration example has been described in which the first authenticator 51, the second authenticator 52, and the third authenticator 53 are provided outside the control unit 20 in the image forming apparatus 1; however, the present invention is not limited thereto. For example, a configuration may be adopted in which the first authenticator 51, the second authenticator 52, and the third authenticator 53 are included in the control unit 20.

Furthermore, in the embodiment and the various modifications described above, an example has been described in which the user authentication technology of the present invention described above is applied to an authentication function of the image forming apparatus 1; however, the present invention is not limited thereto, and the user authentication technology of the present invention can be applied to any device as long as the device has a user's face authentication function.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a first authenticator that extracts first feature information representing a feature of a face of a user from a face image of the user, and performs face authentication by comparing the first feature information extracted with second feature information representing a feature of the face of the user registered in advance; and
a second authenticator that performs authentication of the user by comparing first motion information representing a predetermined motion performed by the user with second motion information representing the predetermined motion of the user registered in advance when at least a part of the information does not match between the first feature information and the second feature information in the face authentication by the first authenticator.

2. The image forming apparatus according to claim 1, wherein
in the face authentication by the first authenticator, when the first feature information completely matches the second feature information or when the first feature information is completely different from the second feature information, the authentication of the user by the second authenticator is not performed.

3. The image forming apparatus according to claim 1, wherein
in the face authentication by the first authenticator, when the first feature information does not completely match the second feature information, the authentication of the user by the second authenticator is performed.

4. The image forming apparatus according to claim 1, wherein
the first authenticator calculates a matching degree between the first feature information and the second feature information as a result of the face authentication.

5. The image forming apparatus according to claim 4, wherein
the second authenticator performs the authentication of the user when the matching degree calculated by the first authenticator is greater than or equal to a predetermined value.

6. The image forming apparatus according to claim 5, further comprising
an operator that enables an administrator of the image forming apparatus or the user to set the predetermined value.

7. The image forming apparatus according to claim 4, wherein
the second authenticator performs one of first authentication or second authentication having higher reliability than the first authentication depending on the matching degree calculated by the first authenticator.

8. The image forming apparatus according to claim 1, wherein
a plurality of types of the second motion information is provided as the second motion information used in the authentication by the second authenticator,
the types of the second motion information are changed every time the authentication by the second authenticator is performed, and
in the authentication by the second authenticator, the second motion information of one of the types used in the authentication is compared with the first motion information corresponding to the one of the types of the second motion information.

9. The image forming apparatus according to claim 1, wherein
a plurality of types of the second motion information is provided as the second motion information used in the authentication by the second authenticator, and
in the authentication by the second authenticator, the authentication is performed by combining the plurality of types of the second motion information.

10. The image forming apparatus according to claim 8, wherein
a plurality of types of the predetermined motions of the user respectively corresponding to the plurality of types of the second motion information includes a gesture, an utterance, a change of a direction of a face, a movement of a line of sight, and blinking of eyes of the user.

11. The image forming apparatus according to claim 1, further comprising
a third authenticator that performs contact type authentication when at least a part of the information does not match between the first feature information and the second feature information in the face authentication by the first authenticator and the first motion information does not match the second motion information in the authentication by the second authenticator.

12. The image forming apparatus according to claim 11, wherein
the authentication by the third authenticator is password authentication.

13. The image forming apparatus according to claim 11, wherein
the authentication by the third authenticator is fingerprint authentication.

14. The image forming apparatus according to claim 1, further comprising an imager that images the face image of the user.

15. A user authentication method, comprising:
extracting first feature information representing a feature of a face of a user from a face image of the user, and performing face authentication by comparing the first feature information extracted with second feature information representing a feature of the face of the user registered in advance; and
performing authentication of the user by comparing first motion information representing a predetermined motion performed by the user with second motion information representing the predetermined motion of the user registered in advance when at least a part of the information does not match between the first feature information and the second feature information in the face authentication.

16. A non-transitory recording medium storing a computer readable user authentication program to be implemented in an information processing apparatus and causing the information processing apparatus to execute a process of:
extracting first feature information representing a feature of a face of a user from a face image of the user, and performing face authentication by comparing the first feature information extracted with second feature information representing a feature of the face of the user registered in advance; and
performing authentication of the user by comparing first motion information representing a predetermined motion performed by the user with second motion information representing the predetermined motion of the user registered in advance when at least a part of the information does not match between the first feature information and the second feature information in the face authentication.
